(19) United States
(12) Patent Application Publication
(10) Pub. No.: US 2005/0206046 A1
(43) Pub. Date: Sep. 22, 2005

(54) Rotary shuttle blow molding apparatus

(76) Inventors: Jeff L. Newman, Wilmington, NC (US); Kenneth H. Bealer, Wilmington, NC (US)

Correspondence Address: WILLIAM J. MASON;MACCORD MASON PLLC, POST OFFICE BOX 1489, WRIGHTSVILLE BEACH, NC, 28480, US

(21) Appl. No.: 10/802,986

(22) Filed: Mar. 17, 2004

(51) Int. Cl. B29C 49/04; B29C 49/36

(52) U.S. Cl. 264/542; 425/532; 425/537; 425/540; 425/541

(57) ABSTRACT

Blow molded containers are formed with a rotary shuttle blow molding apparatus having a plurality of clamps indexable in a horizontal plane around a central axis. Each clamp is moveable between an outer position and an inner position at the central axis. A parison diehead is located near the central axis to extrude at least one parison, with sections of the parison being captured in molds carried by the clamps, which sequentially move beneath the diehead extruder. Each clamp carrying a mold with a captured parison section is then moved to its outer position where the parison is expanded. The clamps then move in a circular pathway to a common discharge station, and are then moved from the discharge station to the parison extruder to receive another parison section.

### BACKGROUND OF THE INVENTION

(1) Field of the Invention

The present invention relates to an apparatus for blow molding plastic containers with calibrated necks, and in particular to a blow molding apparatus in which a plurality of mold clamps that are indexable to stations in a horizontal plane sequentially collect parison sections at a common parison extrusion station, and thereafter unload the containers formed by expansion of the parison sections at a common container discharge station.

(2) Description of the Prior Art

Blow molded containers such as bottles are formed by continuously extruding a parison or tube of plastic material, clamping sections of the parison between mold sections having facing cavity portions, and blowing air into the interior of the parison section while the section is still in a fluid state to expand the parison to conform to the cavity. The container is allowed to cool to a solid state and the mold is opened to discharge the container. The three primary types of apparatus used to form containers in a continuous extrusion manner are vertical rotary blow molding apparatus, horizontal rotary blow molding apparatus, and shuttle blow molding apparatus.

A continuous extrusion vertical rotary blow-molding apparatus typically consists of a plurality of molds positioned around the periphery of a vertical wheel that rotates on a horizontal axle. Each mold consists of two mold halves. The mold is supported by a clamping mechanism that provides a means for opening and closing the mold and applying a clamping force holding the mold halves together during the blow molding process.

An extruder head is positioned to extrude a continuous plastic parison between the mold halves when they are in the open position. As the mold halves rotate to a position where the parison is long enough to cover the entire mold length, the mold halves close capturing the parison. The closed mold supports the parison as it continues to rotate, positioning the parison for the succeeding mold. Once the parison is clamped in the mold, air or other suitable gas is passed through a needle or blow pin into the interior of the parison, expanding the parison to conform to the mold cavity forming the desired container. After the container has cooled, the mold is opened and the bottle ejected.

A horizontal rotary blow molding apparatus typically consists of a plurality of molds carried on table that rotates around a vertical central axis. Indexing of the table moves the clamps in a circle to different positions around the table. At one position, each mold, which has inner faces transverse to the radius of the circle, is clamped onto a section of downwardly extruded parison. After parison clamping, the mold in indexed away from the parison clamping position, with a blow pin being immediately inserted into the parison to expand the parison to the mold cavity configuration. After cooling, the mold is indexed to a discharge station where the cooled container is discharged from the mold.

In shuttle blow molding, a section of a free falling parison extruded at a parison extrusion station is clamped between mold sections. After closing the mold, the parison is cut and the mold moved to a blow station where a blow pin is inserted into the cut parison. The blow pin may be a calibrating blow pin, i.e., a blow pin that having outer dimensions that forms the bottle neck inside diameter, while forcing plastic into the mold cavity to form the bottle closure threads, and introducing air or other suitable gas to inflate the parison. The mold is then opened after the bottle cools to discharge the bottle.

Shuttle blow molding is a relatively slow process. In order to increase production, some shuttle blow molding devices include two linearly aligned clamping stations. Movement of a first mold clamp from the parison extrusion station to a first blowing station moves a second mold clamp linearly to the parison extrusion station. The second clamp is then returned to a second blowing station. Thus, the second station clamps a parison section while the container in the first station is being blown and discharged. One major disadvantage of the dual shuttle configuration is that one-half of the bottles are discharged on one side of the apparatus, while the other one-half of the bottles are discharged on the other side of the apparatus. The linear configuration also limits the apparatus to two mold clamps, resulting in an apparatus that is still relatively slow compared to the continuous rotary blow molding apparatus.

Thus, there is a continuing need for a blow molding apparatus that permits production of containers having openings with calibrated necks while operating at a greater speed and efficiency than conventional shuttle molding apparatus.

### SUMMARY OF THE INVENTION

The present invention provides a blow molding apparatus for forming a plurality of blow molded, calibrated neck containers and a method for forming such containers. Generally, the apparatus is comprised of a plurality of clamps carried on a table that is rotatable about a vertical axis, a multi-parison extruder positioned near or at the vertical axis, a plurality of blow heads to insert air into parisons clamped between molds carried by the table, and a container extractor to remove formed containers. A conveyor may also be provided to convey formed containers to a remote location.

More specifically, the present apparatus includes a table, the term being used herein to broadly describe a support that is rotatable around a vertical axis sequentially through a plurality of indexed positions, and a plurality of mold clamps that are positioned in a horizontal plane equidistant around the table. The number of indexed positions or stations is equal to the number of clamps. While the present invention can be constructed with as few as two clamps, at least three clamps, and thereby stations, is desirable to achieve the improved efficiencies of the apparatus.

Each clamp is moveable between an outer position adjacent the outer edge of the table and an inner position near the central axis of the table. Preferably, the table includes radial trackways along which the clamps are moved, with the trackways intersecting near the central axis of the table. Each clamp is comprised of first and second clamp sections that are movable between an open position and a clamped position. Each clamp section includes an inner surface adapted to support a mold section having an inner face with a depression forming a part of a mold cavity. When joined, the mold sections form a cavity having the shape of the outer surface of the container to be formed and a blow pin opening at the interface of the mold sections. The interface of the mold sections is radially aligned with the table axis.

The apparatus further includes a plurality of blow heads, with one blow head being positioned above the outer position of each clamp. Each blow head includes a plurality of vertically aligned calibrating blow pins movable between raised, retracted positions and lowered, blowing positions. When moved to their lowered positions, the blow pins are adapted to be inserted into pin openings in molds carried by a clamp in its outer position, and have outer dimensions corresponding to the desired inner dimensions of the container neck, thereby calibrating the necks of the containers during blowing.

The multi-parison extruder includes an extruder head with a plurality of extrusion dies adapted to downwardly extrude a plurality of parisons. One or more sources of molten plastic, e.g., screw extruders, are in communication with the extruder head to continuously feed molten plastic to the extruder head. The parisons are continually extruded from the extruder head.

Since parison sections are intermittently clamped between the mold sections, it is necessary to move the extruder head up and down in order to avoid non-clamped parison sections. That is, the extruder head with parisons extruded to the desired length is moveable to a lowered prior to clamping. The clamp is then closed to clamp the parison sections between the mold sections and sever the parisons at the top of the mold sections, either by the clamping action, or by the use of a parison cutter forming a part of the clamp. The parison head is then moveable to a raised position to begin extrusion of the next group of parisons.

Each clamp is indexed by the table sequentially to at least first and second positions, and preferably to at least first, second and third positions located about the table central axis equidistant from each other. When a given first clamp is proximate to, i.e., at or near, the first station, a drive means is adapted to carry the clamp radially inwardly to its inner position beneath the extruder head, with the clamps being in an open position to receive parisons. When the clamp is at the inner position, the extruder head is in its lowered position to insert parisons between mold sections carried on the clamp sections. A clamping mechanism then closes the clamps onto the inserted parisons, which are severed from the remaining upper parts of the parisons.

The first clamp is moved to its outer position beneath its respective blow head while the table is indexing, while the next or second clamp is indexed toward the first station. The blow pins of the blow head associated with the first clamp are moved to their lowered or insertion position to insert the blow pins through the blow pin holes into the parison sections clamped between the mold sections of the first clamp. Air or other fluid is then blown through the pins into the interiors of the parison sections to expand the sections to the shapes of the mold cavities, with the shapes of the blow pins forming calibrated container necks. The thus formed containers are then allowed to cool.

The second clamp carrying open mold sections is then moved inwardly beneath the parison extruder head where parisons are inserted and clamped in the same manner as with the first clamp. Upon further indexing of the table, assuming three clamps are carried on the table, the first clamp moves to a third position to continue cooling the formed containers, the second clamp is moved to the second station where blow pins are inserted into the clamped parisons from the blow head associated with the second clamp, and a third clamp is indexed toward the first station.

The third clamp is then moved radially inwardly to collect parison sections. The table is then further indexed to move the third clamp to the second station for blowing of the clamped parisons, the second clamp is indexed to the third station for further cooling, and the first clamp, now carrying cooled and solidified containers is indexed back to the initial or first station. The first clamp is then opened and moved inwardly to beneath the parison extruder head, leaving the formed containers supported on the blow pins.

The apparatus further includes a container extractor comprised of container clamping sections having an open position and a closed or clamped position. The extractor is adapted to move radially between an inner or extraction position and an outer or discharge position. Following inward movement of the first clamp, the extractor moves to its inner position, with the opposed sections of the extractor clamp being positioned on opposite sides of the formed containers. The extractor clamp is then clamped onto the containers and the blow pins are moved to their raised position to disengage the pins from the containers, so that the extractor supports the containers.

The extractor is then moved to its outer position and the extractor clamp is opened to release the containers onto a conveyor or into a set of trim tooling. Preferably, the apparatus further includes a conveyor positioned beneath the extractor at the extractor outer position to carry released containers away from the extractor to a remote location for further processing.

Thus, in operation the present invention comprises a method of forming blow molded containers in a plurality of molds by the steps of extruding a plurality of parisons at a parison insertion station; moving a first multi-cavity mold from a first station toward the parison insertion station; clamping sections of the parison in the first mold at the parison insertion station; moving the first mold to a second station and expanding the parisons in the first mold to form containers while moving a second multi-cavity mold toward the first station; moving the second mold from the first station to the parison insertion station; clamping sections of the parisons in the second mold at the parison insertion station; moving the second mold to the second station and expanding the parisons in the second mold to form containers while moving a third multi-cavity mold toward the first station and the first mold to a third station; returning the first mold with the containers from the third station to the first station; and extracting the containers from the first mold at the first station.

### BRIEF DESCRIPTION OF THE DRAWINGS

FIG. 1 is a top view of the apparatus in preparation for molding.

FIG. 2 is a top view of the apparatus with parisons being inserted into a mold and finished bottles being clamped by the container extractor.

FIG. 3 is a top view of the apparatus with a mold with captured parison sections being returned from the multi-parison extruder to its outer position beneath a blow head.

FIG. 4 is a sectional side view of parisons being inserted onto a mold beneath the multi-parison extruder.

FIG. 5 is a sectional side view of blow pins being inserted into parisons within the cavities of a clamped mold.

FIG. 6 is a sectional side view of the clamping of finished bottles by the container extractor in preparation of the removal of the bottles from the blow pins and deposition on a conveyor.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

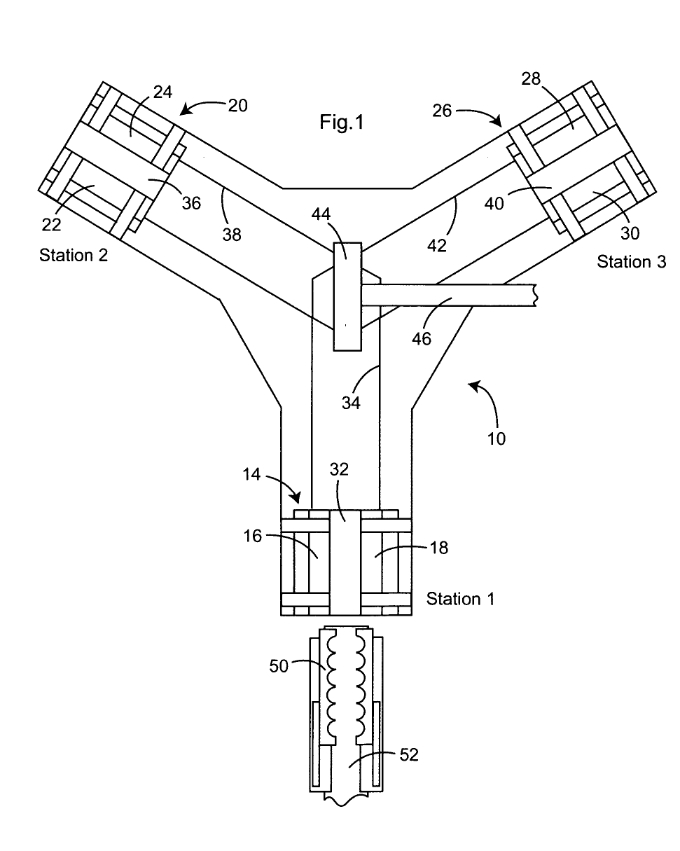

More specifically, the present molding apparatus, generally 10, is comprised of a horizontal table 12 indexable around a vertical central axis to a plurality of indexed positions, shown in the preferred embodiment as three positions. While the preferred embodiment shows three positions, it will be understood by one skilled in the art that apparatus with two or more than three positions can be constructed in accordance with the present invention. A plurality of mold clamps equal to the number of positions is carried on table 10 sequentially to three stations as the table is indexed to the three positions. These stations are identified in FIG. 1 as Station 1, Station 2 and Station 3.

A first mold clamp, generally 14, shown in FIG. 1 as located at Station 1, is comprised of a pair of opposed clamp sections having inner faces supporting mold sections 16 and 18. Each of these mold sections, and the mold sections identified hereinafter, have inner faces with cavities forming a part of a mold cavity with the shape of the desired container. A second mold clamp, generally 20, shown in FIG. 1 as located at Station 2, is comprised of a pair of opposed clamp sections having inner faces supporting mold sections 22 and 24. A third mold clamp, generally 26, shown in FIG. 1 as located at Station 3, is comprised a pair of opposed clamp sections having inner faces supporting mold sections 28 and 30.

Clamp 14 is moveable between an outer position beneath blow head 32 and an inner position at the vertical axis of table 12 along radial trackway 34. Clamp 20 is moveable between an outer position beneath blow head 36 and an inner position at the vertical axis of table 12 along radial trackway 38. Clamp 26 is moveable between an outer position beneath blow head 40 and an inner position at the vertical axis of table 12 along radial trackway 42.

A multi-parison continuous extruder head 44 is positioned above the vertical axis of table 12, and is spaced above the inner positions of clamps 14, 20 and 26. Molten plastic is fed to extruder head 44 through screw extruder 46, which is adapted to raise and lower extruder head 44. Specifically, head 44 is lowered for clamping of parison sections and raised during changing of the clamps. Container extractor 50 comprised of a pair of facing clamp sections is radially aligned with Station 1 and is adapted to move between an inward position for clamping finished containers and an outer position for depositing containers onto a conveyor 52, which is the only discharge conveyor required for the apparatus.

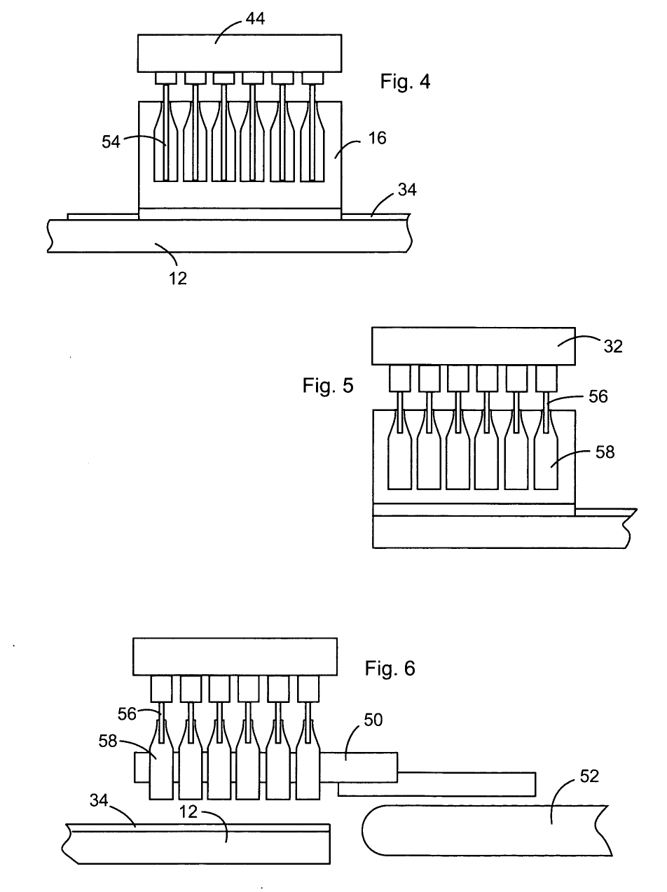

As shown in FIG. 4, extruder 44 is adapted to downwardly extrude a plurality of aligned parisons 54 which are clamped within cavities 52 of a mold. FIG. 5 illustrates insertion of blow pins 56 into parison sections within the mold cavities to expand the parisons to the desired container shape. After expansion and cooling, the finished containers 58 are clamped by container extractor 50 while supported on blow pins 56 as best illustrated in FIG. 6. Blow pins are the same in all blow heads of the apparatus and are all referred to as blow pins 56.

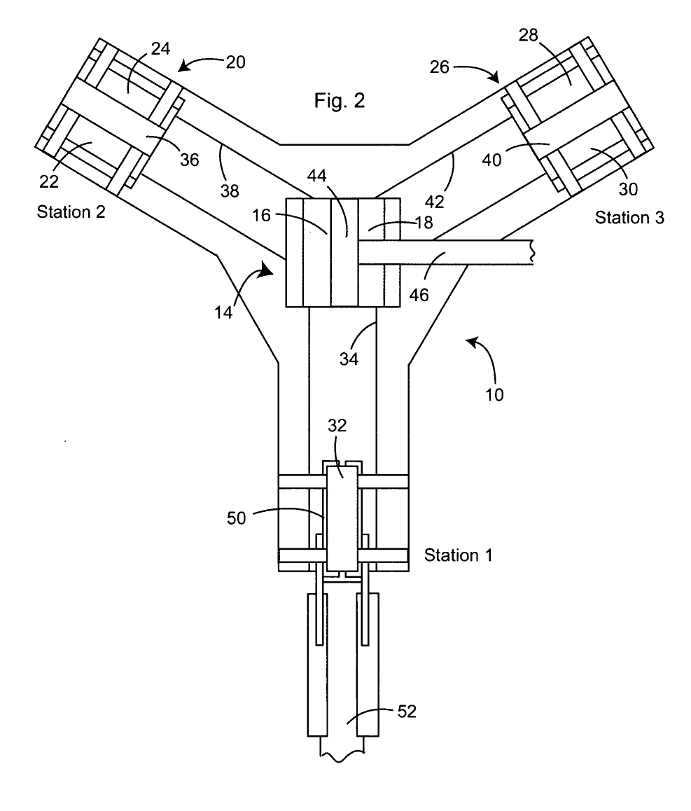

In operation, each clamp is sequentially indexed through the stations. FIG. 1 illustrates clamp 14 after it has just been indexed to Station 1 with a load of finished and cooled containers ready to be discharged. As illustrated in FIG. 2, clamp 14 is opened and moved inwardly along trackway 34 to beneath parison extruder 44 where the clamp is closed to trap parison sections within the multi-cavity mold formed of mold sections 16 and 18. Finished containers 58 are held on blow pins 56 of blow head 32 after mold 14 is opened.

As clamp 14 moves radially inwardly, container extractor 50 also moves radially inwardly to clamp containers 58. After containers 58 are clamped, blow pins 56 are retracted, and extractor 50 moves outwardly to deposit containers 58 on conveyor 52, which conveys containers 58 to another location.

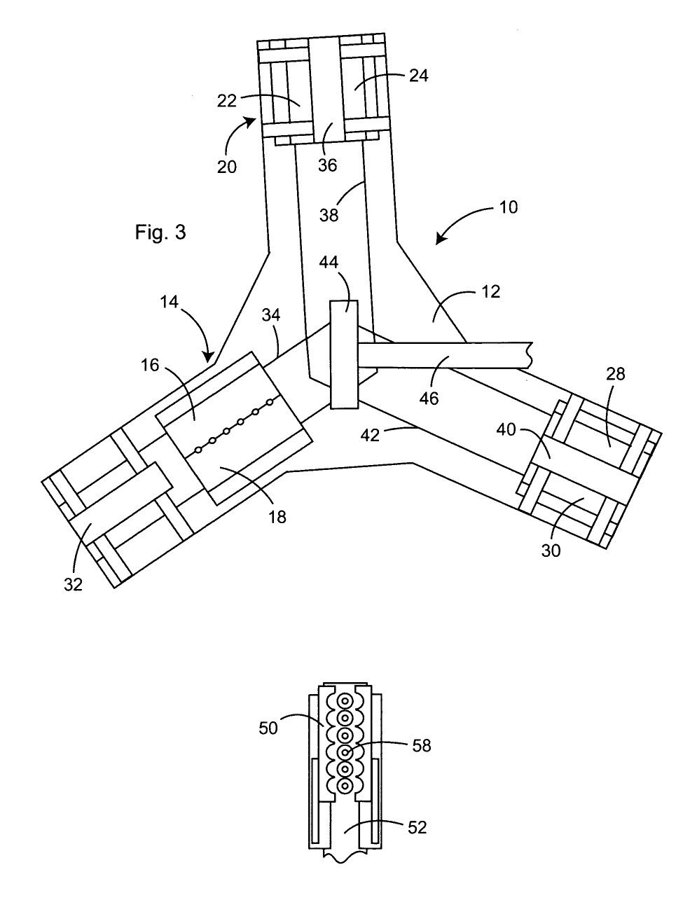

As illustrated in FIG. 3, table 12 is then indexed to the next position, moving blow head 32 to Station 2. Clamp 14 bearing clamped parison sections is moved along trackway 34 to beneath blow head 32. Blow pins are then extended downwardly for insertion into the parison sections, and air is blown through the pins to expand the parison section for the configuration of the mold cavities. As clamp 14 is further indexed to Station 3 and back to Station 1, the containers are cooled for extraction, and the sequence is repeated.

Certain modifications and improvements will occur to those skilled in the art upon a reading of the foregoing description. It should be understood that all such modifications and improvements have been deleted herein for the sake of conciseness and readability but are properly within the scope of the following claims.

1. A rotary shuttle blow molding apparatus comprising:
a) a table rotatable about a vertical central axis, said table having a plurality of indexing stations including a first and second indexing stations in a horizontal plane around said central axis;
b) a parison diehead adapted to downwardly extrude at least one parison positioned at or near said central axis;
c) a plurality of mold clamps carried by said table, each of said clamps being moveable along a horizontal radial pathway from an outer position to an inner position beneath said diehead when said clamp is proximate the first indexing station and from said inner position to said outer position when said clamp is moved from said first indexing station to said second indexing station;
d) blow heads positioned above the outer positions of said clamps, each blow head including at least one blow pin;
e) a container extractor at said first indexing station; and
f) a container receiver positioned to receive containers from said extractor.

2. The apparatus of claim 1, wherein said table has three indexing stations.

3. The apparatus of claim 1, wherein said parison extruder is adapted to extrude a plurality of parisons, and said blow heads each include a number of blow pins equal to the number of parisons extruded by said extruder.

4. The apparatus of claim 1, wherein said parison extruder has a raised position and a lowered position.

5. The apparatus of claim 1, wherein each of said mold clamps is adapted to support a pair of mold halves having inner faces that abut along one of said radial pathways when said clamps are closed.

6. The apparatus of claim 1, wherein the at least one blow pin of each blow head has a raised position and a lowered position.

7. The apparatus of claim 1, wherein the inner positions of said clamps intersect.

8. The apparatus of claim 1, wherein said container extractor includes opposed sections positioned on opposite sides of said radial pathway.

9. The apparatus of claim 1, wherein said extractor is moveable along a radial pathway between an inner position beneath a blow pin head and an outer position, said container receiver being positioned to receive containers from said extractor when said extractor is in its outer position.

10. The apparatus of claim 1, wherein said container receiver is a conveyor.

11. A rotary shuttle blow molding apparatus for forming a plurality of blow molded, calibrated neck containers comprising:
a) a table rotatable about a vertical axis, said table including a first, second and third indexing stations positioned in a horizontal plane equidistant from each other around said axis;
b) a multi-parison extruder positioned at or near said vertical axis;
c) a plurality of mold clamps carried by said table and indexable to said stations, each of said clamps being moveable along a radial pathway from an outer position to an inner position beneath said extruder when said clamp is proximate first indexing station and from said inner position to said outer position when said clamp is moved from proximate said first indexing station to said second indexing station;
d) blow heads positioned above the outer positions of said clamps, each blow head including a plurality of calibrating blow pins equal to the number of parisons extruded by said extruder, said blow pins having raised and lowered positions;
e) a container extractor at said first indexing station; and
f) a conveyor positioned to receive containers from said extractor.

12. The apparatus of claim 14, said extruder having a raised position and a lowered position.

13. The apparatus of claim 11, wherein said extractor is moveable along a radial pathway between an inner container clamping position beneath a blow pin head and an outer container release position above said conveyor.

14. The apparatus of claim 11, wherein the inner positions of said clamps intersect.

15. A method of forming blow molded containers in a plurality of molds comprising:
a) providing a plurality of molds indexable to at least a plurality of stations including at least first and second stations positioned in a horizontal plane around a vertical axis, each of said molds being radially moveable between in inner position at said axis and an outer position;
b) moving a first mold from proximate said first station to its inner position;
c) clamping a section of parison in said first mold at said inner position;
d) moving a second mold toward said first station while moving said first mold to its outer position and to said second station and expanding said parison in said first mold to form a container;
e) returning said first mold with said container to proximate said first station; and
f) extracting said container from said first mold at said first station.

16. The method of claim 15, further including moving said second mold to its inner position, and then moving said second mold to said second station while moving said first mold from said second station to a third station.

17. The method of claim 15, wherein said plurality of stations includes at least first, second and third stations, said stations being positioned equidistant from each other around said axis.

18. The method of claim 17, including the steps of moving said second mold to its outer position and to said second station and expanding said parisons in said second mold to form containers while moving a third multi-cavity mold to said first station and said first mold to said third station, and returning said first mold with said containers from said third station to said first station.

19. The method of claim 17, wherein said third mold is moved to said axis while said second mold is at said second position, and then moved with clamped parison sections to said second position when said first mold is returned to said first position.

20. The method of claim 15, wherein said containers are blown by inserting blow pins into said parison sections, said blow pins supporting said containers until extraction of said containers.
